(19) United States
(12) Patent Application Publication
(10) Pub. No.: US 2015/0256659 A1
(43) Pub. Date: Sep. 10, 2015

(54) Don-Doff Detection using Antenna Detuning

(71) Applicant: Plantronics, Inc., Santa Cruz, CA (US)

(72) Inventor: Jose Abel Hernandez Rueda, Tijuana (MX)

(73) Assignee: Plantronics, Inc., Santa Cruz, CA (US)

(21) Appl. No.: 14/201,643

(22) Filed: Mar. 7, 2014

(51) Int. Cl. H04M 1/04

(52) U.S. Cl. CPC H04M 1/04

(57) ABSTRACT

A wearable device having corresponding computer-readable media comprises: an antenna; a radio-frequency transmitter configured to provide radio-frequency signals to the antenna; a radio-frequency detector having an input electrically coupled to the antenna; an analog-to-digital converter electrically coupled to an output of the radio-frequency detector; and a controller configured to determine whether the wearable device is being worn based on an output of the analog-to-digital converter.

### FIELD

The present disclosure relates generally to the field of wearable devices. More particularly, the present disclosure relates to determining when a wearable device is being worn by a user.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The ability to determine whether a headset is currently being worn (“donned”) or not worn (“doffed”) by a user is useful in a variety of contexts. For example, whether a user's headset is donned or doffed may indicate the user's ability or willingness to communicate, often referred to as user “presence”. The determination of whether a user's headset is donned or doffed, also referred to as “don-doff” detection, is useful in a variety of other contexts.

One conventional approach to don-doff detection employs a sensor capacitive to detect skin contact when the headset is donned. However, such a sensor may also detect skin contact when the headset is being held in the hand, and may therefore lead to a false positive don detection. This approach also requires extra space on the headset to deploy the sensors, and may require multiple capacitive sensors to ensure reliable don-doff detection.

### SUMMARY

In general, in one aspect, an embodiment features a wearable device comprising: an antenna; a radio-frequency transmitter configured to provide radio-frequency signals to the antenna; a radio-frequency detector having an input electrically coupled to the antenna; an analog-to-digital converter electrically coupled to an output of the radio-frequency detector; and a controller configured to determine whether the wearable device is being worn based on an output of the analog-to-digital converter.

Embodiments of the wearable device can include one or more of the following features. In some embodiments, the controller is further configured to determine whether the wearable device is being held based on the output of the analog-to-digital converter. In some embodiments, the radio-frequency detector comprises at least one of: a diode; and a linearized RF detector. In some embodiments, responsive to determining whether the wearable device is being worn, the controller is further configured to perform one or more of the following actions: control media playback; answer a call; power on or power off one or more circuits; route calls; and calibrate sensors. Some embodiments comprise a control circuit electrically coupled to an output of the don-doff logic. Some embodiments comprise a microcontroller comprising the don-doff logic, and the control circuit. Some embodiments comprise a directional coupler electrically coupled between the antenna and the radio-frequency detector. Some embodiments comprise a bandpass filter electrically coupled between the directional coupler and the radio-frequency detector. Some embodiments comprise a headset comprising the wearable device.

In general, in one aspect, an embodiment features a wearable device comprising: an antenna; a radio-frequency transmitter electrically coupled to the antenna; a radio-frequency detector having an input electrically coupled to the antenna; an analog-to-digital converter electrically coupled to an output of the radio-frequency detector; and don-doff logic electrically coupled to an output of the analog-to-digital converter.

Embodiments of the wearable device can include one or more of the following features. In some embodiments, the radio-frequency detector comprises at least one of: a diode; and a linearized RF detector. Some embodiments comprise a control circuit electrically coupled to an output of the don-doff logic. Some embodiments comprise a microcontroller comprising the don-doff logic, and the control circuit. Some embodiments comprise a directional coupler electrically coupled between the antenna and the radio-frequency detector. Some embodiments comprise a bandpass filter electrically coupled between the directional coupler and the radio-frequency detector. Some embodiments comprise a headset comprising the wearable device.

In general, in one aspect, an embodiment features computer-readable media embodying instructions executable by a computer in a wearable device to perform functions comprising: receiving a digital value, wherein the digital value represents an amount of energy returned from an antenna of the wearable device; and determining whether the wearable device is being worn based on the digital value.

Embodiments of the computer-readable media can include one or more of the following features. In some embodiments, the functions further comprise: determining whether the wearable device is being held based on the digital value. In some embodiments, the functions further comprise performing one or more of the following actions responsive to determining whether the wearable device is being worn: controlling media playback; answering a call; powering on or powering off one or more circuits in the wearable device; routing call to or from the wearable device; and calibrating sensors in the wearable device. In some embodiments, the wearable device is a headset.

The details of one or more implementations are set forth in the accompanying drawings and the description below. Other features will be apparent from the description and drawings, and from the claims.

### DESCRIPTION OF DRAWINGS

FIG. 1 is a Smith chart showing three antenna impedance curves for a Bluetooth headset.

FIG. 2 shows actual measurements of antenna SWR for the Bluetooth headset of FIG. 1.

FIG. 3 shows elements of a wireless headset according to one embodiment.

FIG. 4 shows a process for the wireless headset of FIG. 3 according to one embodiment.

The leading digit(s) of each reference numeral used in this specification indicates the number of the drawing in which the reference numeral first appears.

### DETAILED DESCRIPTION

Embodiments of the present disclosure provide don-doff detection for wearable devices using antenna detuning. In the described embodiments, the wearable device is a headset. However, the described techniques may be applied to any suitable wearable device.

The described embodiments makes use of the physical phenomenon of antenna detuning. According to this phenomenon, an antenna will become detuned when it is near a conductive or semi-conductive body, in this case the human body. Different materials have different dielectric constant and conductive properties. The human body is partially conductive, and when close to an antenna can modify the frequency response of the antenna. The antenna source may be a transmitter for wireless communication, such as Bluetooth or DECT, but is not limited to these technologies.

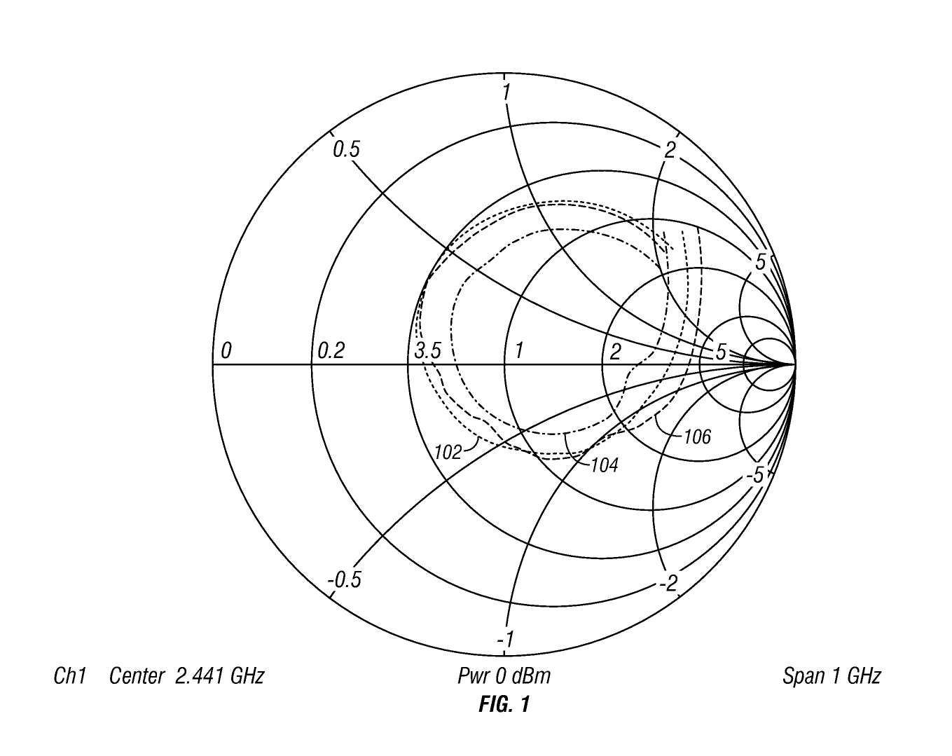

Although detuning alters both the magnitude and phase of the antenna impedance, the “detuning effect” can be quantified using the magnitude alone, as in the described embodiments. In other embodiments, the phase or the magnitude and phase may be used instead. FIG. 1 is a Smith chart showing three antenna impedance curves for a Bluetooth headset. Curve 102 is for the headset when worn on the head. Curve 104 is for the headset when held in the hand. Curve 106 is for the headset when resting on a wooden table. Note the antenna impedance differs significantly for these three cases.

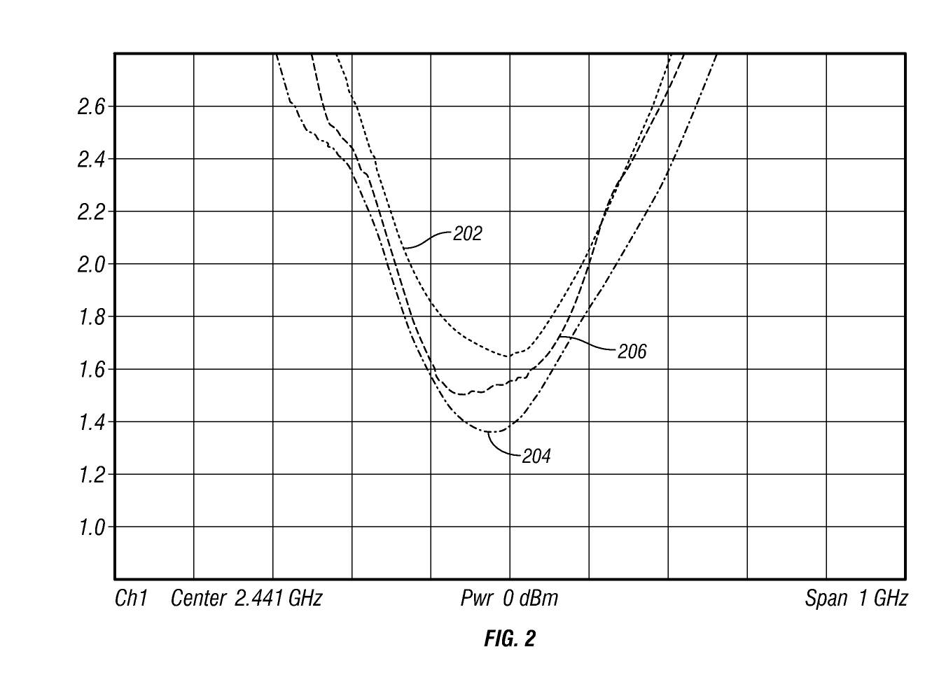

The “detuning effect” can also be quantified using the antenna standing wave ratio (SWR). FIG. 2 shows actual measurements of antenna SWR for the Bluetooth headset of FIG. 1. Curve 202 is for the headset when worn on the head. Curve 204 is for the headset when held in the hand. Curve 206 is for the headset when resting on a wooden table. Note the SWR curves 202, 204, 206 differ significantly for these three cases, and so are easily distinguishable.

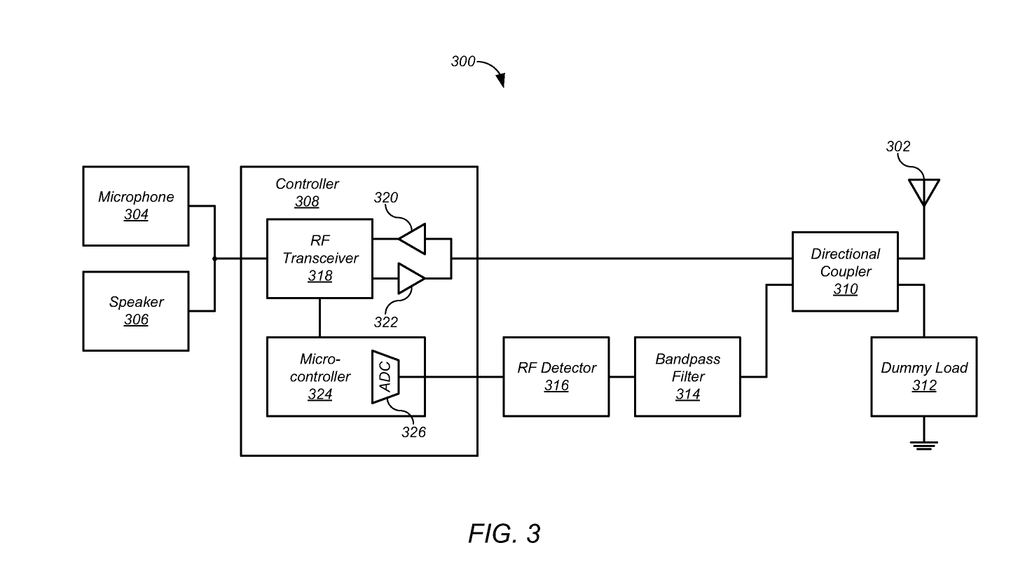

FIG. 3 shows elements of a wireless headset 300 according to one embodiment. Although in the described embodiment elements of the wireless headset 300 are presented in one arrangement, other embodiments may feature other arrangements. For example, elements of the wireless headset 300 may be implemented in hardware, software, or combinations thereof. As another example, various elements of the wireless headset 300 may be implemented as one or more digital signal processors.

Referring to FIG. 3, the wireless headset 300 may include an antenna 302, a microphone 304, a speaker 306, a controller 308, a directional coupler 310, a dummy load 312, a bandpass filter 314, and a radio-frequency (RF) detector 316. The controller 308 may include an RF transceiver 318, a low-noise amplifier 320, an RF power amplifier 322, and a micro-controller 324. The micro-controller 324 may include an analog-to-digital converter 326. In some embodiments, the micro-controller 324 may be implemented as multiple components such as logic, control circuits, and the like.

The RF transceiver 318 may generate RF uplink signals based on uplink audio provided by the microphone 304. The RF uplink signals may be amplified by the RF power amplifier 322, passed by the directional coupler 310, and radiated as wireless uplink signals by the antenna 302. The antenna 302 may receive wireless downlink signals, which may be passed as RF downlink signals by the directional coupler 310, and amplified by the low-noise amplifier 320. The RF transceiver 318 may generate downlink audio based on the RF downlink signals, and may pass the downlink audio to the speaker 306. In some embodiments, the RF transceiver 318 may be augmented by, or replaced by, a dedicated RF source. In embodiments where the dedicated RF source is used with the RF transceiver 318, the dedicated RF source may be in-band (that is, in the same frequency band as the RF transceiver 318) or out-of-band.

The directional coupler 310 may be balanced by the dummy load 312. In one embodiment, the directional coupler 310 may have a characteristic impedance of 50 ohms, and the dummy load 312 may be a 50-ohm resistor. In some embodiments, the directional coupler 310 is a 40 dB directional coupler 310. The directional coupler 310 may sample the returned energy from the antenna 302. The samples may be filtered by the bandpass filter 314. The bandpass filter 314 may be implemented as discrete components, as microstrips, or the like. The parameters for the bandpass filter 314 may vary according to the wireless technology employed. For example, the bandpass may be 2400-2484 MHz for Bluetooth, and may be 1880-1900 MHz for DECT.

The filtered samples may be passed to the RF detector 316. The RF detector 316 may generate a direct-current (DC) voltage based on the filtered samples. In some embodiments, the RF detector 316 may be implemented using a diode such as a Shottky diode. In other embodiment, the RF detector 316 may be implemented as a linearized RF detector. In such embodiments, the bandpass filter 314 may not be needed. In one embodiment, the output of the RF detector 316 may vary in the range of 3-10 mV DC.

The analog-to-digital converter 326 may convert the DC voltage to a digital value. The micro-controller 324 may determine a don-doff state of the wireless headset 300 based on the digital value. Based on the don-doff state, the micro-controller 324 may take one or more actions such as routing audio to or from the wireless headset 300.

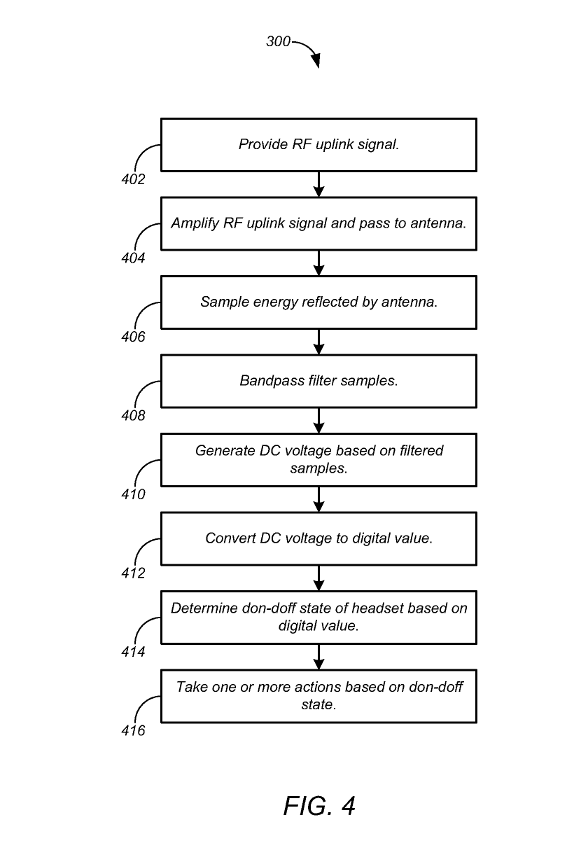

FIG. 4 shows a process 400 for the wireless headset 300 of FIG. 3 according to one embodiment. Although in the described embodiments the elements of process 400 are presented in one arrangement, other embodiments may feature other arrangements. For example, in various embodiments, some or all of the elements of process 400 can be executed in a different order, concurrently, and the like. Also some elements of process 400 may not be performed, and may not be executed immediately after each other. In addition, some or all of the elements of process 400 can be performed automatically, that is, without human intervention.

Referring to FIG. 4, at 402, the RF transceiver 318 may provide an RF uplink signal. The RF uplink signal may employ a standard modulation format, may be a special-purpose beacon, or the like. At 404, the RF uplink signal may be amplified by the power amplifier 322, and passed to the antenna 302 through the directional coupler 310.

At 406, the directional coupler 310 may sample the energy reflected by the antenna 302. At 408, the bandpass filter 314 may filter the samples. At 410, the RF detector 316 may generate a DC voltage based on the filtered samples. At 412, the analog-to-digital converter 326 may convert the DC voltage to a digital value. At 414, the micro-controller 324 may determine a don-doff state of the wireless headset 300 based on the digital value. For example, the micro-controller 324 may make a decision as to whether the wireless headset 300 is being worn, is being held, or is resting on a table. Table 3 shows a mapping of the DC voltages into the decision of the micro-controller 324 according to one embodiment. The voltage values may depend on the specific implementation, and may include signal smoothing techniques such as averaging over time, environmental calibration, sample estimation, and the like.

TABLE 1

| Voltage v (mV DC) | Decision |
|---|---|
| 1 < v < 3 | Hand |
| 3 ≦ v < 6 | Table |
| 6 ≦ v < 10 | Head |

At 416, the micro-controller 324 may take one or more actions based on the don-doff state. For example, these actions may include routing audio to or from the wireless headset 300, controlling media playback from a media player, answering a call, powering on or powering off one or more circuits in the wireless headset 300, calibrating sensors in the wireless headset 300, and the like. For example, when the wireless headset 300 is donned, the micro-controller 324 may cause audio to be routed to and from the wireless headset 300.

Various embodiments of the present disclosure can be implemented in digital electronic circuitry, or in computer hardware, firmware, software, or in combinations thereof. Embodiments of the present disclosure can be implemented in a computer program product tangibly embodied in a computer-readable storage device for execution by a programmable processor. The described processes can be performed by a programmable processor executing a program of instructions to perform functions by operating on input data and generating output. Embodiments of the present disclosure can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. A wearable device comprising:
an antenna;
a radio-frequency transmitter configured to provide radio-frequency signals to the antenna;
a radio-frequency detector having an input electrically coupled to the antenna;
an analog-to-digital converter electrically coupled to an output of the radio-frequency detector; and
a controller configured to determine whether the wearable device is being worn based on an output of the analog-to-digital converter.

2. The wearable device of claim 1, wherein the controller is further configured to determine whether the wearable device is being held based on the output of the analog-to-digital converter.

3. The wearable device of claim 1, wherein the radio-frequency detector comprises at least one of:
a diode; and
a linearized RF detector.

4. The wearable device of claim 1, wherein, responsive to determining whether the wearable device is being worn, the controller is further configured to perform one or more of the following actions:
control media playback;
answer a call;
power on or power off one or more circuits;
route calls; and
calibrate sensors.

5. The wearable device of claim 1, further comprising:
a control circuit electrically coupled to an output of the don-doff logic.

6. The wearable device of claim 5, further comprising:
a microcontroller comprising
the don-doff logic, and
the control circuit.

7. The wearable device of claim 1, further comprising:
a directional coupler electrically coupled between the antenna and the radio-frequency detector.

8. The wearable device of claim 7, further comprising:
a bandpass filter electrically coupled between the directional coupler and the radio-frequency detector.

9. A headset comprising the wearable device of claim 1.

10. A wearable device comprising:
an antenna;
a radio-frequency transmitter electrically coupled to the antenna;
a radio-frequency detector having an input electrically coupled to the antenna;
an analog-to-digital converter electrically coupled to an output of the radio-frequency detector; and
don-doff logic electrically coupled to an output of the analog-to-digital converter.

11. The wearable device of claim 10, wherein the radio-frequency detector comprises at least one of:
a diode; and
a linearized RF detector.

12. The wearable device of claim 10, further comprising:
a control circuit electrically coupled to an output of the don-doff logic.

13. The wearable device of claim 12, further comprising:
a microcontroller comprising
the don-doff logic, and
the control circuit.

14. The wearable device of claim 10, further comprising:
a directional coupler electrically coupled between the antenna and the radio-frequency detector.

15. The wearable device of claim 14, further comprising:
a bandpass filter electrically coupled between the directional coupler and the radio-frequency detector.

16. A headset comprising the wearable device of claim 10.

17. Computer-readable media embodying instructions executable by a computer in a wearable device to perform functions comprising:
receiving a digital value, wherein the digital value represents an amount of energy returned from an antenna of the wearable device; and
determining whether the wearable device is being worn based on the digital value.

18. The computer-readable media of claim 17, wherein the functions further comprise:
determining whether the wearable device is being held based on the digital value.

19. The computer-readable media of claim 17, wherein the functions further comprise performing one or more of the following actions responsive to determining whether the wearable device is being worn:
controlling media playback;
answering a call;
powering on or powering off one or more circuits in the wearable device;
routing call to or from the wearable device; and
calibrating sensors in the wearable device.

20. The computer-readable media of claim 17, wherein the wearable device is a headset.
